(19) United States
(12) Patent Application Publication
(10) Pub. No.: US 2014/0338127 A1
(43) Pub. Date: Nov. 20, 2014

(54) BLANKET WITH PET POCKET

(71) Applicant: Lisa M. Latime, Richmond, CA (US)

(72) Inventor: Lisa M. Latime, Richmond, CA (US)

(21) Appl. No.: 14/279,719

(22) Filed: May 16, 2014

Related U.S. Application Data
(60) Provisional application No. 61/824,583, filed on May 17, 2013.

(51) Int. Cl. A01K 1/035; A47G 9/02

(52) U.S. Cl. CPC A01K 1/035; A47G 9/0223
USPC 5/485

(57) ABSTRACT

A blanket with a pet pocket comprising a front and back surface large enough to cover a bed; a pocket on the front surface smaller than the front surface, wherein the pocket includes a top opening large enough for a household domestic pet to fit comfortably inside.

This application claims the benefit of U.S. provisional application No. 61/824,583 filed May 17, 2013, which is incorporated herein in its entirety by reference.

### FIELD OF THE INVENTION

The present invention relates to a blanket with a pet pocket. In particular, the blanket includes pocket on the front side with a top opening large enough to comfortably fit a household domestic pet, preferably a dog or cat.

### BACKGROUND OF THE INVENTION

A large percentage of pet owners allow their pets to sleep in the bed with them, either under the blankets/sheets or on top of the blankets/sheets. Most pets shed, some more than others. Thus, when the family pet sleeps with their owner there is a problem with pet hair, dander and dirt from the pet that will be in or on the owner's bed linen.

In general, blankets with pockets are known. Representative examples include the following.

Fleece cuddle blanket with a pocket for eyeglasses or a remote control is disclosed at www.comforthouse.com/heatwoolmatp.html. This blanket is used by an individual watching television and prevents them from losing the remote control as well as a place to cover their legs and feet.

Pet pockets and cuddle blankets are disclosed at www.pawnation.com/2009/06/23/pet-pockets-and-cuddle-blankets. These pet pockets are essentially a pillow, rather than a blanket, having a slip opening for small tea-cup size dogs. This pet pillow is a travel dog bed.

Design Pat. No. 305,844 shows a blanket with a pocket. The pocket is formed by folding the square blanket with three folds which are held together by ties.

None of these references provides a solution to pet hair, dander and dirt problems when the pet sleeps with the owner in the owner's bed.

The invention does provide a solution to this problem by providing a blanket with a pocket on the front side with a top opening large enough to comfortably fit a household pet such as a dog or cat.

A general objective of the invention is to provide a blanket to keep the pet owner and the pet together in the same bed but in contact with separate components.

An object of the invention is to provide a blanket to permit owners and their pets to sleep together in a clean manner free of pet hair, dander and dirt.

Another object of the invention is to provide a blanket to accommodate all size household pets, from large too small, including but not limited to a dog and cat.

Yet another object of the invention is to provide a pet pocket which is removable from the blanket and easily washed and cleaned.

Still another object of the invention is to provide a blanket with a pet pocket to be used either on the floor, couch or traveling in the car.

### SUMMARY OF THE INVENTION

In the present invention, these purposes, as well as others which a blanket is provided having a front and back surface large enough to cover a bed; a pocket on the front surface which is smaller than the front surface. The pocket includes a top opening large enough for a household pet such as a dog or cat to fit comfortably inside.

The blanket and pocket are made of materials selected from the group consisting of fabrics, cotton, fleece, polar fleece, lamb wool, faux lamb wool, imitation sheep skin, hemp, faux suede, leather, satin, polyester, silk, silk blended fabrics, organic fabrics and blended products.

The blanket itself could be a single layer or multiple layers and may even be filled with foam, polyester or down.

In one embodiment the pocket is permanently attached to the blanket. Preferably, the pocket is sewn directly into the front surface of the blanket.

In an alternate embodiment the pocket is removable so that it can be washed separately from the blanket. The removable pocket is held in place on said blanket using means including buttons, Velcro® or hook and loop tape, double side tape or a zipper.

The pocket size varies depending on the size of the pet. The pocket accommodates household pets such as cats and small dogs up to large dogs such as the Labrador retriever. Although, any domesticated household pet can use the pocket, including guinea pigs and others. The pocket is preferably lined with fleece for comfort of the pet, but can be any of the above mentioned materials as well as a mixture of materials.

The blanket pocket may optionally include a draw string along said top opening. When the draw string is pulled closed the pet is secured in the pocket.

The pocket has a width depending on the bed and animal size but is typically in the range of at least 5 inches or more, preferably 10 inches or more.

The pocket has a length depending on the bed and animal size but is typically in the range of at least 5 inches or more, preferably 10 inches or more.

The blanket is large enough to fit king (76″), California king (72″), queen (60″), full (54″), single (39″) and day beds.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a general view of the components of the invention where the pet pocket is approximately the same size as the blanket; and

FIG. 2 is another embodiment of the invention, where the pet pocket is smaller than the blanket size.

### DETAILED DESCRIPTION OF THE INVENTION

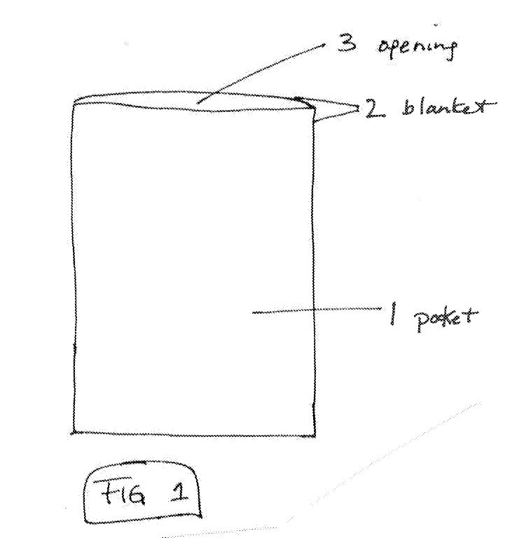

As illustrated in FIG. 1, the invention provides a blanket having a front and back surface 2 large enough to cover a bed; a pocket 1 on the front surface which is smaller than the front surface. The pocket includes a top opening 3 large enough for a household pet, such as a dog or cat pet to fit comfortably inside.

The blanket and pocket are made of materials selected from the group consisting of fabrics, cotton, fleece, polar fleece, lamb wool, faux lamb wool, imitation sheep skin, hemp, faux suede, leather, satin, polyester, silk, silk blended fabrics, organic fabrics and blended products.

The blanket itself could be a single layer or multiple layers and may even be filled with foam, polyester or down.

In one embodiment the pocket is permanently attached to the blanket. Preferably, the pocket is sewn directly into the front surface of the blanket.

In an alternate embodiment the pocket is removable so that it can be washed separately from the blanket. The removable pocket is held in place on said blanket using means including buttons, Velcro® or hook and loop tape, double side tape or a zipper, along the three sides of the pocket attached to the front surface.

In an alternate embodiment, the blanket is made of a material where the removable pocket can be placed anywhere desired on the surface. This provides flexibility to the owner to move the pet into different sleeping areas on the bed.

The pocket size varies depending on the size of the pet. The pocket can be circular, square or rectangular, but in all embodiments the pocket has an opening large enough for the pet to climb inside. The pocket is designed to accommodate pets as small as cats or guinea pigs and small dogs up to large dogs such as the Labrador retriever. Although, the pocket is designed and intended for use, by any domesticated household pet. The pocket is preferably lined with fleece for comfort of the pet.

In an alternate embodiment the pocket includes a draw string along the top opening. When the draw string is pulled closed the pet is secured and snug in the pocket.

The pocket has a width depending on the bed and animal size but is typically in the range of at least 5 inches or more, preferably 10 inches or more.

he pocket has a length depending on the bed and animal size but is typically in the range of at least 5 inches or more, preferably 10 inches or more.

The blanket is large enough to fit king (76″), California king (72″), queen (60″), full (54″), single (39″) and day beds.

A removable pocket for a domestic pet is provided, wherein the pocket comprises three sides with a top opening large enough for a household domestic pet to fit comfortably inside; and the pocket is secured on a blanket; wherein each pocket side is held in place on the blanket using buttons, hook and loop tape, double sided tape or a zipper.

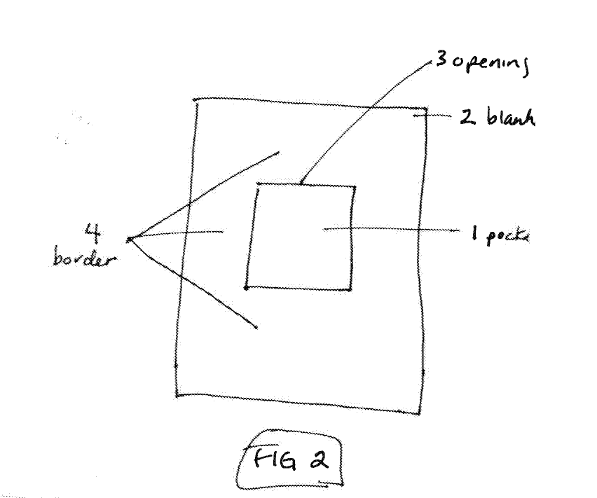

FIG. 2 illustrates this alternate embodiment of the invention. The pocket 1 is situated in the middle of the blanket 2 and is surrounded by a blanket border 4. There is a top opening 3 for the household pet to climb inside. The blanket border is preferably 4 to 10 inches and is dependent on the size of the pet dog or cat.

In this removable pocket embodiment the blanket and pocket are made of materials selected from the group consisting of fabrics, cotton, fleece, polar fleece, lamb wool, faux lamb wool, imitation sheep skin, hemp, faux suede, leather, satin, polyester, silk, silk blended fabrics, organic fabrics and blended products.

The pocket has a width at least 5 inches and a length of at least 5 inches.

The blanket is large enough to fit king, California king, queen, full, single and day beds.

The pocket is lined with fleece.

The pocket includes a draw string along said top opening. The draw string is pulled closed to secure pet in the pocket.

By being removable the invention pocket provides easy cleaning of both the blanket and the pocket. This is advantageous because most domestic pets shed a good deal of fur which is not easy to remove and clean from blankets. The invention overcomes this problem by providing a removable pocket which secures the pet on top of the owner's bed but permits easy removal for cleaning.

While the invention is described as being preferably used on a bed, it may also be used on other surfaces, such as the floor, couch, or even as a travel blanket in a car.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A blanket comprising:
a front and back surface large enough to cover a bed;
a pocket on said front surface smaller than said front surface, wherein said pocket includes a top opening large enough for a household domestic pet to fit comfortably inside.

2. The blanket according to claim 1, wherein the blanket and pocket are made of materials selected from the group consisting of fabrics, cotton, fleece, polar fleece, lamb wool, faux lamb wool, imitation sheep skin, hemp, faux suede, leather, satin, polyester, silk, silk blended fabrics, organic fabrics and blended products.

3. The blanket according to claim 1, wherein said pocket is removable.

4. The blanket according to claim 3, wherein said pocket is held in place on said blanket using means including buttons, hook and loop tape, double side tape or a zipper.

5. The blanket according to claim 1, wherein the pocket has a width at least 5 inches.

6. The blanket according to claim 1, wherein the pocket has a length at least 5 inches.

7. The blanket according to claim 1, wherein the blanket is large enough to fit king, California king, queen, full, single and day beds.

8. The blanket according to claim 1, wherein said pocket is lined with fleece.

9. The blanket according to claim 1, wherein said pocket includes a draw string along said top opening.

10. The blanket according to claim 9, wherein said draw string is pulled closed to secure pet in the pocket.

11. A removable pocket for a domestic pet, wherein the pocket comprises three sides with a top opening large enough for a household domestic pet to fit comfortably inside; and the pocket is secured on a blanket; wherein each pocket side is held in place on the blanket using buttons, hook and loop tape, double sided tape or a zipper.

12. The removable pocket according to claim 11, wherein the blanket and pocket are made of materials selected from the group consisting of fabrics, cotton, fleece, polar fleece, lamb wool, faux lamb wool, imitation sheep skin, hemp, faux suede, leather, satin, polyester, silk, silk blended fabrics, organic fabrics and blended products.

13. The removable pocket according to claim 11, wherein the pocket has a width at least 5 inches.

14. The removable pocket according to claim 11, wherein the pocket has a length at least 5 inches.

15. The removable pocket according to claim 11, wherein the blanket is large enough to fit king, California king, queen, full, single and day beds.

16. The removable pocket according to claim 1, wherein said pocket is lined with fleece.

17. The removable pocket according to claim 1, wherein said pocket includes a draw string along said top opening.

18. The removable pocket according to claim 17, wherein said draw string is pulled closed to secure pet in the pocket.
